(19) United States
(12) Patent Application Publication
(10) Pub. No.: US 2012/0234827 A1
(43) Pub. Date: Sep. 20, 2012

(54) ONE-PIECE MICROWAVEABLE PACKAGE

(75) Inventors: Oscar Reiniero Perez, Vitacura (CL); Sona Plencnerova, Singen (DE); Loic Faulon, Thollon Les Memises (FR)

(73) Assignee: NESTEC S.A., Vevey (CH)

(21) Appl. No.: 13/000,404

(22) PCT Filed: Jun. 16, 2009
(86) PCT No.: PCT/EP2009/057484

§ 371 Date: Apr. 18, 2011

(30) Foreign Application Priority Data
Jun. 26, 2008 (EP) 08104552.8

(51) Int. Cl. H05B 6/80

(52) U.S. Cl. 219/725

(57) ABSTRACT

The present invention concerns a one-piece microwaveable package for a food product, said package having the shape of a sleeve comprising top, bottom and a first and second side walls, wherein the first side wall links the top and bottom wall, wherein the top wall comprises at least one notch or aperture located in its free edges and the second side wall extends the bottom wall and comprises on its free edge at least one corresponding extension that is suitable for locking with the notch or aperture of the top wall so as to lock the package in its erected position.

The present invention concerns a one-piece microwaveable package, as well as an assembly comprising said microwaveable package.

The U.S. Pat. No. 4,785,160 concerns a disposable, sleeve type carton formed from foldable paperboard, coated with electrically conductive material to assist in browning a food item. The problem with this type of packaging is that the package is closed on the four sides, which is leads to an overheating of the food product when introduced and heated in a microwave device. The package of this patent is made of solid board.

The objective of the present invention is to have a packaging device, wherein the food product heated reaches a good crispiness and browning features in the microwave device, to be close to a heating in a classical oven device.

The present invention concerns a one-piece microwaveable package for a food product, said package having the shape of a sleeve comprising top, bottom and two side walls, wherein the first side wall links the top and bottom wall, wherein the top wall comprises at least one notch or aperture located in its free edges and the second side wall extends the bottom wall and comprises on its free edge at least one corresponding extension that is suitable for locking with the notch or aperture of the top wall so as to lock the package in its erected position.

According to a second embodiment of the invention the invention concerns a one-piece microwaveable package for a food product, said package having the shape of a sleeve comprising top, bottom and a first and a second side walls, wherein the first side wall links the top and bottom walls and the top wall comprises at least one notch or aperture cooperating with at least one corresponding extension of the bottom wall for locking the package in its erected position.

The objective of the invention is to have a package, wherein by introducing the food product in said package, there is a close contact between said food product and the package, leading to a better crispiness of the heated product.

Furthermore, the top and bottom walls comprise at least one venting opening. The reason of the presence of this or these openings is to create grill marks around the opening and allow moisture evacuation during the microwave heating. Preferably the top and bottom walls comprise two venting openings. There is no criticality in the form and the size of the opening. Preferably, the opening is elongated and has a size slightly below the size of the diagonal of the top and bottom wall.

The sleeve for the package comprises an external paper layer, a flute layer and an internal susceptor to be in contact with the food product.

The flute layer has a thickness comprised between 0.3 and 2 mm. preferably, the flute layer has a thickness of around 0.8 mm. The paper layer is a grease proof layer.

Concerning the type of susceptor used, it has preferably an optical density to obtain a higher adsorbed energy and less transmitted energy. For example, the susceptor is made of PET with a thin layer of aluminium.

According to a further embodiment of the invention, the bottom side of said package comprises at least three, preferably four precuts that can be unfolded downwardly from the bottom wall, so as to form there, preferably four corresponding feet, in the erected position. With this type of solution, when the package is placed in a microwave oven, the bottom wall of the package is not in direct contact with the oven walls: the consequence is that it increases the air circulation, which allows a better evaporation of the moisture and allows better distribution of the microwave on the bottom part, especially in low quality Microwave oven.

The package has preferably a top and bottom wall with a size comprised between 8 and 15 cm. The width of the side walls is comprised between 2 and 4 cm.

In a further embodiment, the sleeve is formed from one blank folded, flat and wherein one side wall is glued against the top wall.

The present invention concerns further the use of the above described package to obtain a food product with grill marks, with a good crispiness and approaching a heated product as in a classical oven. The duration for heating the food product with a package of the invention is ranging to 3 min with a microwave oven having a power of around 750 Watts.

The present invention concerns further an assembly comprising in an enclosure a food product and a one-piece microwaveable package as described above. In a practical way, the food is a croque monsieur. This assembly can be considered as well for retail, as for foodservice area. The assembly comprises a locking system, which is more consumer friendly, that means with less material and with a easy handling.

The object of the invention will be apparent from the following drawings, wherein

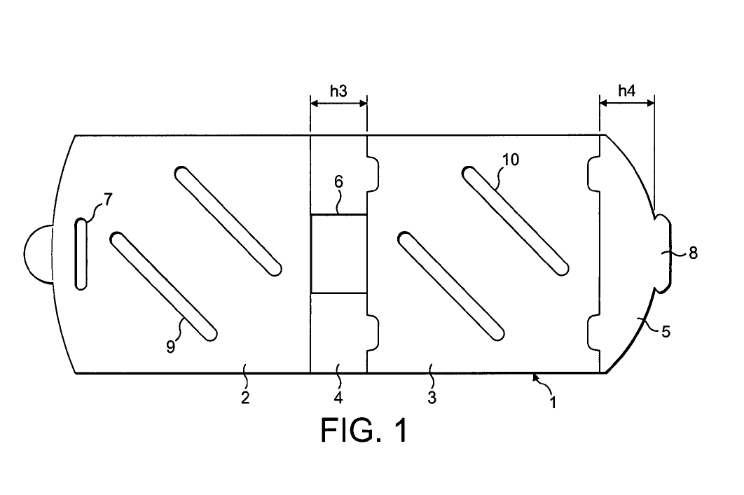

FIG. 1 is a plan view of the blank in a first embodiment of the invention,

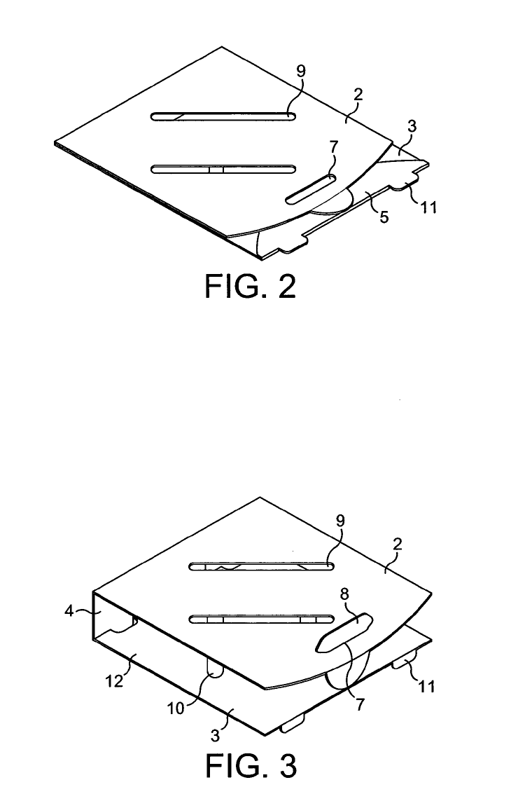

FIG. 2 is a plan view of the sleeve according to the preceding embodiment,

FIG. 3 is a perspective view with the sleeve in an erected position,

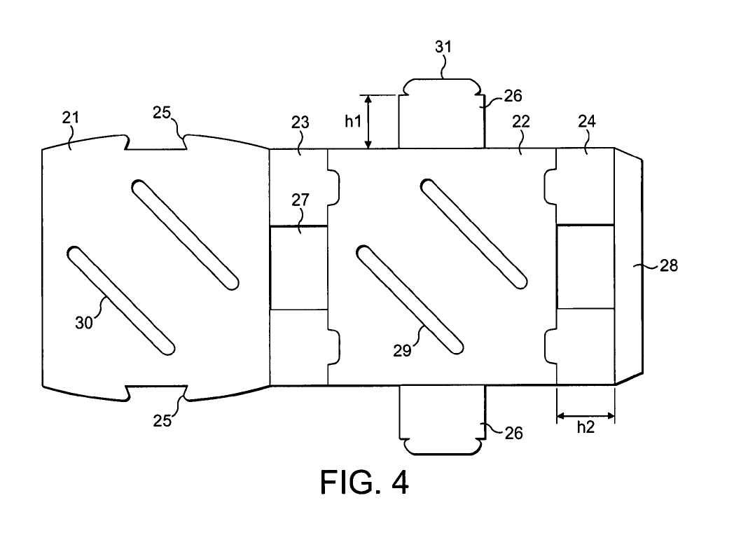

FIG. 4 is a plan view of the blank in a second embodiment of the invention,

FIG. 5 is a plan view of the sleeve of FIG. 4 and

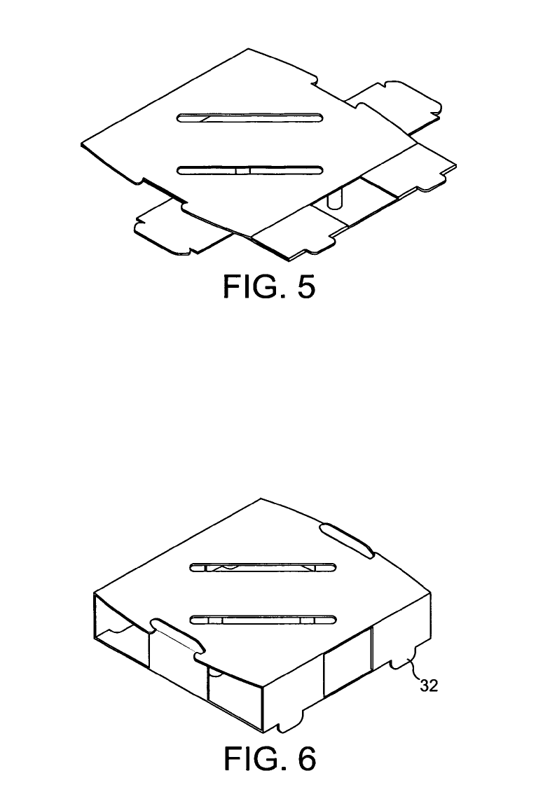

FIG. 6 is a perspective view in an erected position of this second embodiment.

The microwaveable package is made from an one-piece blank (1) comprising a top wall (2), a bottom wall (3), a first side wall (4), linking both walls (2) and (3)and a second side wall (5). The side wall (4) presents an aperture (6). The top wall (2) presents an aperture (7) cooperating with the extension (8) of the second side wall for locking the package in its erected position. On this figure, the blank presents 2 ventings (9) in the top wall and 2 ventings (10) in the bottom wall.

FIG. 2 shows the blank folded, that means as a sleeve as normally supplied by the manufacturer of package. The top wall (2) is glued against the second side wall (5). When the consumer want to use the package he has only to unfold the sleeve and then place the extension (8) in the aperture (7) to have the package as erected on FIG. 3. At this stage, the consumer can introduce the croque monsieur through the opened side (12). In this embodiment, the height h4 of the second side wall is smaller than the height h3 of the first side wall. The reason is that in this case both top and bottom walls are in closer contact with the food to be heated, increasing therefore the crispiness and browning. In the erected position, the feet (11) are visible on FIG. 3.

According to the second embodiment of FIGS. 4 to 6, the microwaveable package is made from an one-piece blank (20) comprising a top wall (21), a bottom wall (22), a first side wall (23) and a second side wall (24), wherein the first side wall (23) links the top and bottom walls and the top wall (21) comprises at least one notch (25) cooperating with 2 extensions (26) of the bottom wall for locking the package in its erected position. The second side wall comprises further and extension (28) to be glued against the top wall (21).

The FIG. 5 shows the blank folded, that means a blank normally supplied by the manufacturer of package. In this case, the part (28) is glued against top wall (21). When the consumer wants to use the package he has only to erect the sleeve as in FIG. 6, introduce the croque-monsieur inside the sleeve and then place the extensions (26) in the corresponding notch (25) of the top wall (21). The package comprises furthermore feet (32). As for the preceding embodiment, the height h2 of the second side wall is smaller than the height h1 of the first side wall, as before to increase the contact of the food with the susceptor.

1. A one-piece microwaveable package for a food product, the package having a shape of a sleeve comprising a top, bottom and a first and second side wall, the first side wall links the top and bottom wall, the top wall comprises at least one notch or aperture located in a free edge and the second side wall extends from the bottom wall and comprises on a free edge at least one corresponding extension that is suitable for locking with the notch or aperture of the top wall so as to lock the package in an erect position.

2. A one-piece microwaveable package for a food product, the package having a shape of a sleeve comprising a top, bottom and a first and a second side wall, the first side wall links the top and bottom walls and the top wall comprises at least one notch or aperture cooperating with at least one corresponding extension of the bottom wall for locking the package in an erect position.

3. A one-piece microwaveable package according to claim 1, wherein the top and bottom walls comprise at least one venting opening.

4. A one-piece microwaveable package according to claim 3, wherein the top and bottom walls comprise two venting openings.

5. A one-piece microwaveable package according to claim 3, wherein the venting openings are elongated.

6. A one-piece microwaveable package according to claim 1, wherein the sleeve comprises an external paper layer, a flute layer and an internal susceptor layer that contacts the food product.

7. A one-piece microwaveable package according to claim 6, wherein the flute layer has a thickness of between 0.3 to 2 mm.

8. A one-piece microwaveable package according to claim 6, wherein the paper layer is a grease proof layer.

9. A one-piece microwaveable according to claim 6, wherein the susceptor layer has an optical density so as to absorb greater energy and transmit less energy.

10. A one-piece microwaveable package according to claim 1, wherein the bottom side of the package comprises at least three precuts, that can be unfolded downwardly from the bottom wall, so as to form there, corresponding feet in the erect position.

11. A one-piece microwaveable package according to claim 1, wherein the top and bottom walls have a size of between 8 and 15 cm.

12. A one-piece microwaveable package according to claim 1, wherein the width of the side walls is between 2 and 4 cm.

13. An assembly comprising in an enclosure a food product and a one-piece microwaveable package for a food product, the package having a shape of a sleeve comprising a top, bottom and a first and second side wall, the first side wall links the top and bottom wall, the top wall comprises at least one notch or aperture located in a free edge and the second side wall extends from the bottom wall and comprises on a free edge at least one corresponding extension that is suitable for locking with the notch or aperture of the top wall so as to lock the package in an erect position.

14. An assembly according to claim 13, wherein the food product is a croque-monsieur.

15. A one-piece microwaveable package according to claim 2, wherein the top and bottom walls comprise at least one venting opening.

16. A one-piece microwaveable package according to claim 15, wherein the top and bottom walls comprise two venting openings.

17. A one-piece microwaveable package according to claim 15, wherein the venting openings are elongated.

18. A one-piece microwaveable package according to claim 2, wherein the sleeve comprises an external paper layer, a flute layer and an internal susceptor layer that contacts the food product.

19. A one-piece microwaveable package according to claim 18, wherein the flute layer has a thickness of between 0.3 to 2 mm.

20. A one-piece microwaveable package according to claim 18, wherein the paper layer is a grease proof layer.

21. A one-piece microwaveable according to claim 18, wherein the susceptor layer has an optical density so as to absorb greater energy and transmit less energy.

22. A one-piece microwaveable package according to claim 2, wherein the bottom side of the package comprises at least three precuts, that can be unfolded downwardly from the bottom wall, so as to form there, corresponding feet, in the erect position.

23. A one-piece microwaveable package according to claim 2, wherein the top and bottom walls have a size of between 8 and 15 cm.

24. A one-piece microwaveable package according to claim 2, wherein the width of the side walls is between 2 and 4 cm.

25. An assembly comprising in an enclosure a food product and a one-piece microwaveable package for a food product, the package having a shape of a sleeve comprising a top, bottom and a first and a second side wall, the first side wall links the top and bottom walls and the top wall comprises at least one notch or aperture cooperating with at least one corresponding extension of the bottom wall for locking the package in an erect position.

26. An assembly according to claim 25, wherein the food product is a croque-monsieur.
